(19) United States
(12) Patent Application Publication
(10) Pub. No.: US 2023/0405836 A1
(43) Pub. Date: Dec. 21, 2023

(54) ROTARY GRIPPER

(71) Applicant: Afag Holding AG, Zell (CH)

(72) Inventors: Friedrich DURAND, Rüttenen (CH); Tobias FRASCH, VS-Tannheim (DE); Ramon FELDER, Etziken (CH); Steffen SCHÜTZ, Kaiserslautern (DE)

(21) Appl. No.: 18/211,803

(22) Filed: Jun. 20, 2023

(30) Foreign Application Priority Data
Jun. 21, 2022 (EP) 22180154.1

(51) Int. Cl. B25J 15/00

(52) U.S. Cl. CPC B25J 15/0038

(57) ABSTRACT

A rotary gripper having two gripping jaws and an actuating mechanism displaceable along a displacement path and rotatable about a rotational axis. The gripping jaws are displaced and/or swiveled during displacement of the actuating mechanism and rotation of the actuating mechanism leads to joint rotation of the gripping jaws about the rotational axis. The rotary gripper has a magnet, a magnetic field sensor and a processing device. The magnet is attached to the actuating mechanism so that a magnetizing direction runs at an angle to the rotational axis. The magnetic field sensor is arranged to detect the magnetic field of the magnet and to detect components of the magnetic flux density of the magnetic field for at least two spatial directions. The processing device is set up, depending on the components of the magnetic flux density detected, to detect rotational information relating to a rotational angle of the joint rotation of the gripping jaws and gripping information relating to the gripping position.

### CROSS-REFERENCE TO RELATED APPLICATIONS

The present application claims priority of EP 22180154.1, filed Jun. 21, 2022, the priority of this application is hereby claimed, and this application is incorporated herein by reference.

### BACKGROUND OF THE INVENTION

The invention relates to a rotary gripper having two gripping jaws and an actuating means which is mounted by a bearing means, particularly formed by a housing, so as to be linearly displaceable along a displacement path and rotatable about a rotational axis running parallel to the displacement path, wherein the actuating means is movement-coupled with the gripping jaws in such a manner that the gripping jaws are displaced and/or swiveled during a displacement of the actuating means along the displacement path in opposite directions to one another, in order to adopt different gripping positions, and that a rotation of the actuating means about the rotational axis leads to a joint rotation of the gripping jaws about the rotational axis.

Rotary grippers of this kind which are used, for example, to grip and rotate components in production or equipping processes, are well-known per se. Rotary grippers with the model names DG 16 and DG 20, for example, are supplied by the applicant. In this case, using a joint actuating means for both degrees of freedom of movement makes for a particularly compact design. The customary models currently on the market are usually pneumatically controlled. In principle, however, other actuators can also be used, for example direct electromotive actuation or hydraulic actuation.

During the operation of rotary grippers of this kind, it is frequently desirable for the rotation and/or the gripper movement to be monitored. This may be desirable, for example, in order to achieve desired gripping or rotational settings with a high degree of accuracy through the use of a control circuit, in order to validate the function of the rotary gripper, in other words to identify a blocking of the rotational or gripping movement, for example, and/or to control components mounted downstream or upstream, in order to synchronize them with the gripping or rotational movements.

Separate sensors have hitherto been used to detect the two degrees of freedom of movement, in other words the gripping and rotational movement. It is known in this case for magnetic field sensors to be used for both degrees of freedom of movement which are inserted as separate components in so-called C-grooves in the outside of the housing of the rotary gripper and fixed there. This attachment is in need of improvement for multiple reasons.

Firstly, the correct positioning of the respective sensor in the respective groove is extremely important to the measuring accuracy, so that the arrangement of separate sensors during the installation of a system comprising a rotary gripper in the field is relatively laborious. In addition, the arrangement on the outside of the housing leads to the sensors being relatively susceptible to interfering external fields, meaning that an expensive additional shield has to be installed in respect of linear drives, for example, which are frequently used along with rotary grippers. In addition, the sensor system which has been used hitherto is relatively expensive.

### SUMMARY OF THE INVENTION

The invention is therefore based on the object of specifying an improved attachment for detecting the gripping and rotational movement of a rotary gripper, wherein the assembly work and the susceptibility to interference, in particular, are to be reduced and additional costs for detecting the aforementioned variables are to be kept low.

The object is achieved according to the invention by a rotary gripper of the kind referred to above, wherein the rotary gripper has a magnet, a magnetic field sensor and a processing device, wherein the magnet is attached to the actuating means in such a manner that a magnetizing direction runs at an angle, in particular perpendicularly, to the rotational axis, wherein the magnetic field sensor is arranged in a stationary manner relative to the bearing means, such that the magnetic field of the magnet can be detected by the magnetic field sensor, wherein the magnetic field sensor is set up to detect components of the magnetic flux density of the magnetic field for at least two spatial directions, wherein the processing device is set up, depending on the components of the magnetic flux density detected, to detect rotational information relating to a rotational angle of the joint rotation of the gripping jaws and gripping information relating to the gripping position.

Through the angled or, in particular, perpendicular course of the magnetization direction to the rotational axis and the detection of components of the magnetic flux density for two spatial directions, a distinction can be made between a displacement of the magnet in relation to the magnetic field sensor, and therefore the bearing means or the housing, and a rotation about the rotational axis. While a rotation of the magnet, and therefore of the actuating means and the gripping jaws, leads to a change in the field direction, as a result of which the ratio of the detected components in relation to one another changes, a displacement of the magnet, and therefore of the actuating means, and therefore a gripping movement of the gripping jaws results in the distance from the magnetic field sensor and magnet changing, as a result of which the detected components rise or fall uniformly.

By measuring the two components, the degrees of freedom of movement can be separated and therefore both the rotational information and the gripping information can be supplied, although only a single magnet is used. Since, in addition, magnetic sensors which can detect multiple field components are available in a relatively inexpensive and compact form, the rotary gripper according to the invention can be produced at relatively low cost and detection of the rotational information and gripping information can be implemented with little effort in terms of installation space.

One example of a magnetic field sensor of this kind is the module MLX90395 from Melexis which is also available as an SMD component, for example, and can even detect components for three spatial directions of the magnetic field standing perpendicular to one another. When using this sensor, it has proved advantageous for the field strength of the magnet and the minimum and maximum intervals occurring along the displacement path between the magnet and magnetic field sensor to be selected in such a manner that a maximal field strength of approx. 45 mT and a minimal field strength of approx. 12 mT occur at the sensor. In the meantime, however, since a plurality of different magnetic field sensors with different properties is available, which can detect two or three components of the magnetic flux density, other field intensity ranges can also be used as required.

It may be advantageous for components of the magnetic field intensity to be detected and evaluated for three spatial directions, since in this way a robust distinction can be made between a change in direction of the field line and a scale of the field due to a change in distance. Since in the rotary gripper which has been explained, there is a limitation to precisely two degrees of freedom of the movement of the actuating means, and therefore of the magnet, namely the rotational movement about the rotational axis and the displacement along the displacement path, it has proved sufficient in preliminary tests for only two components to be evaluated for spatial directions which are at an angle to one another.

In this case, two spatial directions which are perpendicular to one another, in particular, are taken into account. When components for only two spatial directions are taken into account, losses in the accuracy of the detection only occur when the angle of the field lines passing through the magnetic field sensor to the plane formed by the spatial directions taken into account, which plane is particularly perpendicular to the rotational axis, changes substantially in the context of the movement of the actuating means. However, this is only the case with the embodiment explained in greater detail below, if the magnet is moved very close to the magnetic field sensor, although this is not usually the case with typical structures.

The procedure which has been described enables the components needed for rotational and gripping detection, namely the magnets and the magnetic field sensor, to be integrated in the rotary gripper during the production thereof and, in particular, in the housing thereof. Consequently, the intricate arrangement of additional sensors explained above can be avoided and typically no separate shielding is required either, since the magnetic field sensor is usually already adequately shielded by the housing of the rotary gripper itself.

The gripping information and the rotational information can be used to validate a desired movement, for example to identify an obstruction to the rotation and gripping or release, and to issue a warning signal in this case. The warning signal can be issued directly by the rotary gripper itself, for example optically or acoustically, or customary communications interfaces can be used to report corresponding information, for example to a central control mechanism of a machine which includes the rotary gripper.

In addition or alternatively, the gripping information or the rotational information can also be used for control purposes, for example, in order to allow more accurate rotational and/or gripping movements, and/or can be used to control devices upstream or downstream devices, as has already been discussed above. With the help of the gripping information, it is also possible to detect, for example, whether an object has been correctly gripped, since in this case the gripping jaws are held at a certain distance from one another, while the gripping jaws are moved substantially further together when reaching past the object.

The gripping information and rotational information can be repeatedly detected during a movement of the rotary gripper, for example, in order to monitor the entire movement path. The detected components and the result, in other words the gripping or rotational information, can also be averaged over multiple measurements, however, in order to reduce interference. In this case, it may be advisable for monitoring to be only of those end positions at which the gripping jaws are located which have been reached, since during movement the averaging would result in the current status not being correctly reproduced. Averaging may be particularly advantageous when, due to a relatively small shielding of the magnetic field sensor against external interference fields, or on account of strong external interference fields, measurement of the components of the magnetic flux density supplied by the magnet itself is impaired.

Insofar as in the present case orientations are described as parallel or perpendicular, tolerance-based deviations are possible in this case, wherein a permitted deviation may, in particular, be smaller than 2° or smaller than 1° or smaller than 0.5°.

The processing device may for example be integrated in a sensor module implementing the magnetic field sensor, for example in an IC, or it may be arranged as a separate component within, or on, the housing of the rotary gripper, for example on a printed circuit board which also carries the magnetic field sensor. Alternatively, the processing device may also be spaced apart from the rotary gripper or from the housing thereof. In particular, it may also be used to control or to monitor further components of a machine which includes the rotary gripper, for example motors, other rotary grippers, etc.

The magnet may be adhered to the actuating means. Alternatively, however, it could also be fastened thereto by extrusion-coating, hot caulking or screw fixing. The actuating means may, in particular, be rod-shaped or cylindrical.

The actuating means may extend from an end coupled with the gripping jaws in the direction of the displacement path up to an end facing away from the gripping jaws, wherein the magnet is arranged on the end of the actuating means facing away from the gripping jaws, and is particularly arranged on an end face of the actuating means facing away from the gripping jaws. This arrangement is particularly favorable when the magnetic field sensor is arranged on the side of the actuating means facing away from the gripping jaws. This kind of arrangement of the magnetic field sensor can be advantageous, since in this case there is no conflict in terms of installation space with the actuator used for moving the actuating means, for example with pneumatic chambers or coupling means for coupling to an electromechanical actuator. In particular, a disc-shaped magnet can be used, the magnetization direction of which lies in the plane of its main faces. Alternatively, however, a rod magnet can also be used, the poles of which preferably lie on a plane which is perpendicular to the rotational axis.

The actuating means may be formed from a material which has a relative magnetic permeability at its end facing away from the gripping jaws of less than 4 or less than 2 or less than 1.5. A sufficiently small magnetic permeability in this range makes it possible for the field guidance of the magnet to be influenced very little, even if the material encloses the magnet to the side at least partially. The use of material with a low permeability in this region is particularly advantageous when the actuating means is surrounded at its end by a housing, or generally by a shield with a high magnetic permeability, as will be further explained later. If the end of the actuating means were also to exhibit high magnetic permeability in this case, the field lines of the magnet would lead directly to this housing or to this shield. By using material with a low magnetic permeability in the aforementioned range, a region within a housing of this kind, or a shield of this kind, which receives the magnet and the magnetic field sensor may, however, facilitate substantially undisturbed field guidance between these components.

The material may, in particular, be only weakly paramagnetic or even weakly diamagnetic. For example, the relative magnetic permeability may be between 0.9 and 1.1 or the deviation from a relative magnetic permeability of 1 may even be less than 10⁻³ or 10⁻⁴. Suitable materials are, for example, brass, which is typically weakly diamagnetic, depending on the specific alloy, or aluminum, which is weakly paramagnetic.

The magnetic field sensor may be arranged on a side of the actuating means facing away from the gripping jaws and spaced apart from the actuating means in the direction of the displacement path. In particular, the magnetic field sensor may be arranged displaced in the direction of the displacement path to the magnet. The distance of the displacement in this case is evidently dependent on the displacement position of the actuating means along the displacement path, wherein this is preferably delimited in such a manner, however, that contact between the magnet and the magnetic field sensor is avoided.

If the magnetization direction of the magnet is substantially perpendicular to the displacement path, when the field influence by the other components of the rotary gripper is not too strong, or is at least roughly rotationally symmetrical, and when the distance between the magnetic field sensor and magnet is not too small, a course of the field lines in the region of the magnetic field sensor is substantially perpendicular to the rotational axis. In this case, it is sufficient, for example, for only two components of the magnetic flux density to be detected perpendicular to the rotational axis, in order to determine the rotational information and gripping information with a high degree of accuracy.

At least one portion of the actuating means can be received in a receiving space formed by the, or a, housing of the rotary gripper, wherein the magnetic field sensor is arranged on a side of a side wall of the receiving space facing away from the receiving space, wherein the side wall is formed at least sectionally from a material which has a relative magnetic permeability of less than 4 or less than 2 or less than 1.5. As already explained above for the material of the end of the actuating means, the relative magnetic permeability may, in particular, deviate only slightly from 1, wherein the limits referred to above can be used here too. For example, the side wall may be formed from aluminum or, alternatively, also from brass.

The use of the side wall, in order to separate the magnetic field sensor from the actuating means or the receiving space thereof, is particularly advantageous when the displacement of the actuating means is pneumatically actuated. For example, a pressure chamber which is divided into two partial chambers by a portion of the actuating means in the manner of a piston can be formed by the receiving space. By applying pressure to these partial chambers, the actuating means can therefore be pneumatically displaced, in order to displace or swivel the gripping jaws. The arrangement of the magnetic field sensor outside a pressure chamber of this kind may, on the one hand, avoid mechanical loads on the magnetic field sensor or electrical components connected thereto, which can occur when there are sudden changes in pressure or turbulence resulting from this. On the other hand, the arrangement of the magnetic field sensor outside the pressure chamber means that said pressure chamber is easier to seal, as no, or at least fewer, electrical connection lines have to be conducted into the pressure chamber.

The side wall may have a recess, for example, on its side facing away from the receiving space, with which recess the magnetic field sensor engages or into which it is inserted. For example, the magnetic field sensor may be arranged on one side of a printed circuit board facing the side wall and project from said printed circuit board in the direction of the side wall. The magnetic field sensor may be supported against the side wall, in order to avoid or minimize vibrations in the magnetic field sensor in relation to the side wall or the housing or the bearing means. For example, the heat conductor sensor may be clamped between the side wall and a printed circuit board, wherein a heat-conducting film, or the like, can also be clamped between the side wall and magnetic field sensor, in order to balance the tolerances.

The, or a, housing of the rotary gripper may exhibit a first housing component with which the actuating means engages, and which delimits the receiving space along with the side wall designed as a separate component, wherein on the side of the side wall facing away from the receiving space, a further receiving space is delimited by a second housing component along with the side wall. The structure which has been described enables the pressure gripper to be mounted in a relatively straightforward manner. In addition, through a suitable choice of material for the housing component, in particular by using ferromagnetic materials, a robust shielding of the magnetic field sensor in respect of external fields can be achieved.

The displacement path may run at an angle of at least 30° or at least 60°, in particular perpendicular, to a plane which is formed by the spatial directions or second spatial directions, for which components of the magnetic field can be detected by the magnetic field sensor. The sensitivity of the detection can be maximized by the displacement path running as perpendicular as possible to the aforementioned plane. This applies, in particular, when the magnetization direction of the magnet lies substantially in the aforementioned plane, so is roughly perpendicular to the rotational axis, or forms an angle of at least 30° or at least 60° therewith.

The rotary gripper may have a shield or the housing may form a shield which encloses a sensor region, within which the magnetic field sensor is arranged, in the circumferential direction in relation to the rotational axis and/or which ends the sensor region on a side of the sensor region facing away from the magnet, wherein the shield is formed by a material with a relative magnetic permeability of at least 300. The sensor region may, in particular, correspond to the further receiving space explained above, which is ended by the second housing component. This housing component may, in particular, form the shield as has been explained.

The permeability limit indicated means that it is a ferromagnetic shield. A material with a higher magnetic permeability, for example with a relative magnetic permeability of at least 700 or more than 1000 or more than 10,000 is preferably used as the shield material. External fields are substantially shielded in all directions by the shield, from which there should be no field detection for detecting the field lines of the magnet of the rotary gripper itself. In this way, the influence of interference sources external to the rotary gripper, for example magnets of linear motors, on the gathering of gripping and rotational information can be substantially reduced.

So that the course of the magnetic field lines of the magnet is detrimentally affected by the shield to the smallest possible extent or so that the smallest possible number of field lines run past the sensor due to the shield, it is advantageous for a certain minimum distance to be observed between the magnetic field sensor and that part of the shield that ends the sensor region on the side facing away from the magnet. This minimum distance can be selected so as to be comparable with the maximum distance possible between the magnet and magnetic field sensor when the displacement path is utilized, for example at least 20% of this distance, at least 50% of this distance, or is at least equal to this distance.

At least the, or a, portion of the actuating means may be received in the, or a, receiving space formed by the, or a, housing of the rotary gripper, wherein the displacement of the actuating means along the displacement path is limited in such a manner that the magnet is arranged within the receiving space in all displacement positions of the actuating means, wherein the receiving space is limited in the circumferential direction in relation to the rotational axis by the, or a, material which has a relative magnetic permeability of at least 300.

The boundary of the receiving space may, in particular, be formed by the first housing component explained above, which may act as a shield due to the choice of material. The material is, as the material of the shield explained above, a ferromagnetic material, and, as likewise explained above, a material with an even higher magnetic permeability is preferably used. For example, the shield explained above and the boundary of the receiving space may be formed by the same material. Due to the receiving space being delimited by a ferromagnetic material, an input of external interference fields from the region to the side of the magnet or the displacement path is substantially completely suppressed. The shielding of the magnetic field sensor in respect of the interference fields can therefore be further improved.

The processing device of the rotary gripper may be set up, on the one hand, depending on the detected components of the magnetic flux density, to determine a measurement for an amount, either of the magnetic flux density or of the magnetic flux density projected into the plane formed by the spatial directions, and to determine the gripping information depending on this measurement, and/or on the other hand, to determine a ratio of the detected components of the magnetic flux densities or two of these components, and to determine the rotational information depending on this ratio.

As has already been explained, the gripping movement of the gripping jaws correlates with the position of the actuating means along the displacement path, and therefore with the distance between the magnet and the magnetic field sensor. Since the amount of the magnetic flux density decreases monotonically with the distance of the magnet from the magnetic field sensor, this amount is a good measure of the distance.

If this distance were to be determined for arbitrary relative orientations of the magnet and magnetic field sensor, components of the magnetic flux density for three spatial directions, which do not lie in a plane, would have to be determined. In the rotary gripper that has been explained, however, the limited degrees of freedom of movement mean that it can be assumed at least approximately that the angle between the direction of the field lines of the magnet and a plane perpendicular to the rotational axis in the region of the magnetic field sensor does not change at least approximately. It may therefore be sufficient for components for two spatial directions, which may particularly lie in this plane, to be taken into account.

In order to calculate the amount of the magnetic flux density or of the projected magnetic flux density, the root of the sum of the squares of the components must be calculated. To reduce the amount of calculation and therefore, for example, the cost of the processing calculation or the energy consumption thereof, rather than a highly complex root calculation, however, the total of the component squares can be directly used as a measurement for the amount of the magnetic flux density, for example. A measurement of this kind or the amount can then be converted with the help of a look-up table, for example, or by calculating an analytical relationship in the distance or the gripping position.

In relation to determining the rotational information, it is initially assumed, for example, that the spatial directions for which components of the magnetic flux density are detected are perpendicular to one another and lie in a plane which is perpendicular to the rotational axis. In this case, the tangent of the rotational angle corresponds to the ratio of the components. The rotational angle can therefore easily be calculated from this ratio or determined with the help of a look-up table, for example.

This calculation can be transferred accordingly to the detection of components in an obtuse-angled coordinate system or for spatial directions which are oblique to the aforementioned plane. As a general rule, however, in these cases too, a rotational angle can be directly determined from the ratio, for example with the help of a suitable look-up table.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

FIG. 1 an exemplary embodiment of a rotary gripper according to the invention, and

FIG. 2 data structures relevant to determining the rotational and gripping information.

### DETAILED DESCRIPTION OF THE INVENTION

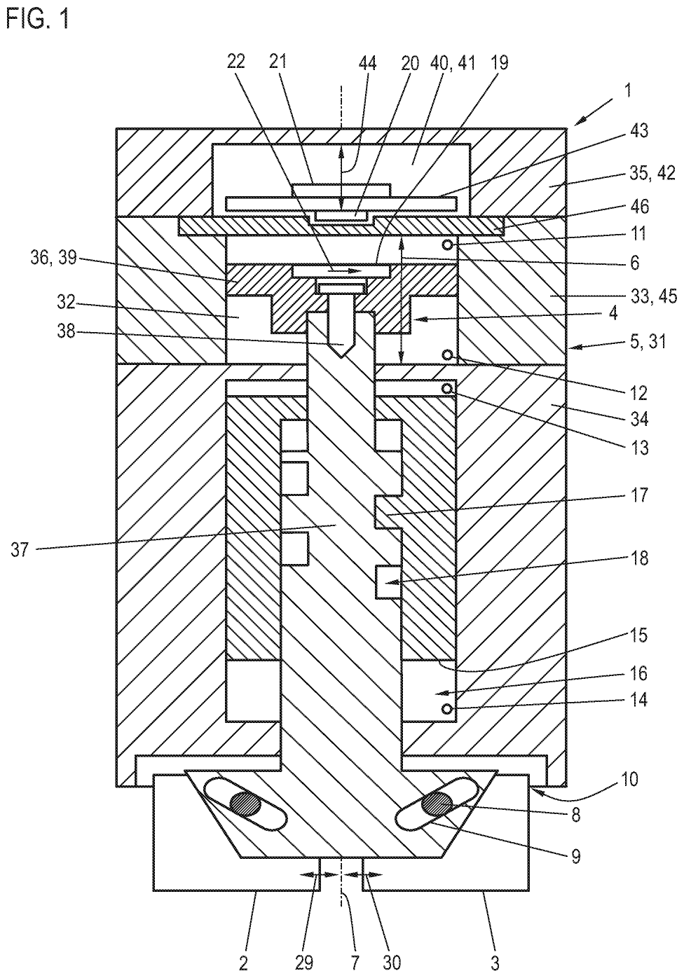

FIG. 1 shows a rotary gripper 1 with two gripping jaws 2, 3, which, on the one hand, can be displaced in the transverse direction in FIG. 1 in opposite directions to one another, as depicted by arrows 29, 30, in order to perform a gripping movement or to clamp an object between the gripping jaws 2, 3 and, on the other hand, are jointly rotatable about the rotational axis 7. The two degrees of freedom of movement are implemented by a common actuating means 4, which is mounted so as to be linearly displaceable along a displacement path 6 and rotatable about a rotational axis 7 running parallel to the displacement path 6 by a bearing means 5, which is formed by a housing 31 of the rotary gripper 1 in the example.

The actuating means 4 in this case is coupled with the gripping jaws 2, 3 in such a manner that a displacement of the actuating means 4 along the displacement path 6 lead to a movement of the gripping jaws 2, 3 opposite one another. This is achieved in that the gripping jaws are fastened to the housing 31 by forced guidance 10, which blocks a displacement of the gripping jaws 2, 3 in the vertical direction in FIG. 1. At the same time, the gripping jaws 2, 3 each have a strut which passes through a respective opening 9 in the actuating means 4. The openings 9 in this case extend at an angle to the rotational axis 7 or the displacement path 6, so that a displacement of the actuating means 4 in the vertical direction in FIG. 1 due to the forced guidance 10 and the forced guidance through the opening 9 leads to a movement of the gripping jaws 2, 3 perpendicularly to the rotational axis 7, as depicted by the arrows 29, 30. This coupling also results in a rotation of the actuating means 4 leading to a rotation of the gripping jaws 2, 3 about the rotational axis 7.

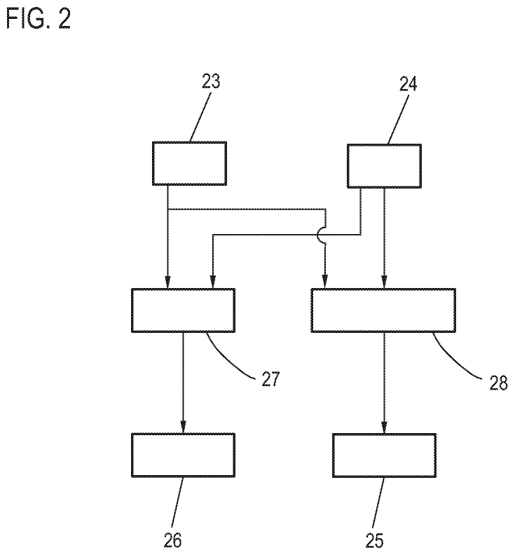

In order firstly to determine rotational information 25 affecting the rotation of the gripping jaws 2, 3, and secondly to determine gripping information 26 affecting the gripping position of the gripping jaws 2, 3, the rotary gripper 1 has a magnet 19, a magnetic field sensor 20, and a processing device 21. The magnetic field sensor 20 and the processing device 21 are supported by a joint printed circuit board 43 in the example. In order to reduce vibrations, it may be advisable for the magnetic field sensor to be clamped between the printed circuit board 42 and the side wall 46, wherein a thermally conductive film, or the like, may also be arranged to balance the tolerance between the side wall 46 and the magnetic field sensor 20. The determination of the aforementioned variables is explained in greater detail with additional reference to FIG. 2.

The magnet 19 in the example is attached to the end face of the actuating means 4 facing away from the gripping jaws 2, 3, for example adhered there, and has a magnetizing direction 22 which runs at an angle, in the example perpendicular, to the rotational axis 7. At least two components of the magnetic flux density of the magnetic field of the magnet 19 are detected by the magnetic field sensor 20. As has already been explained in the general part, it may under some circumstances be advantageous for a magnetic field sensor 20 to be used, which detects the components for three spatial directions. It is assumed in the example, however, that only two components of the magnetic flux density are detected for spatial directions which are perpendicular to one another and perpendicular to the rotational axis 7.

As is schematically depicted in FIG. 2, a measurement 27 for the amount by which the magnetic flux density projects into the plane perpendicularly to the rotational axis 7 can be determined from the two components 23, 24 of the magnetic flux density detected in the region of the magnetic field sensor 20. The measurement may directly be the amount that can be calculated as the root of the component squares or, in order to simplify the calculation, only the total of the component squares may be used as the measurement, for example.

The amount, and therefore the measurement 27, is a good measurement for the distance between the magnet 19 and the magnetic field sensor 20, and therefore for the position of the magnet 19, and therefore of the actuating means 4, along the displacement path 6, and therefore in turn for the gripping position of the gripping jaws 2, 3. It is namely known in the art for the amount of the magnetic flux density at one location to be strictly monotonically dependent on the distance from the field source, in other words, in the rotary gripper 1, on the distance from the magnet 19.

If the amount should be determined from components of the magnetic flux density, it would generally be necessary for components of the magnetic flux density to be detected for three spatial directions. With the geometry of the rotary gripper 1 as shown, it can be assumed, however, that the field lines of the magnet 19 in the region of the magnetic field sensor 20 are roughly perpendicular to the rotational axis, or at least that the angle between the field lines and the plane standing perpendicularly to the rotational axis 7, in which the spatial directions for which components of the magnetic flux density are detected, lie, does not change. Based on this assumption, the amount by which the magnetic flux density projects into the aforementioned plane is scaled, as with the overall amount of the magnetic flux density, so that this amount of the projected magnetic flux density, or the measurement 27 for this amount, represents a good measurement for the gripping information 26, which can therefore be determined with the help of a look-up table, for example, or a previously determined analytical relationship, directly from the measurement 27 for the amount.

On the other hand, a rotation of the actuating means 4 about the rotational axis 7 means that only the direction of the field lines, in which they pass through the magnetic field sensor 20, changes. Consequently, the relationship 28 of the two detected components 23, 24 corresponds to the tangent of the rotary angle of the actuating means 4 about the rotational axis 7, with which the rotational information 25 can be directly determined from this.

The integration of the magnet 19 and of the magnetic field sensor 20 in the rotary gripper 1, as described, means that no further separate components are needed, in order to determine the rotational information 25 and the gripping information 26, as a result of which the assembly of machines or systems which include the rotary gripper 1 can be made substantially easier. At the same time, the housing 31 of the rotary gripper 1 can also be used, in order to shield from potentially interfering external magnetic fields, as a result of which a robust detection of the rotational information 25 and the gripping information 26 is possible, even in usage situations in which strong leakage fields occur, for example when used in the region of linear motors. Various formulations for using the rotational information 25 and the gripping information 26 have already been explained in the general section.

In the example shown, the movement and rotation of the actuating means 4 takes place pneumatically. The end of the actuating means 4 facing away from the gripping jaws 2, 3 is arranged in a receiving space 32 or a pressure chamber, which is jointly delimited by the side wall 46 and the housing components 33, 34. This pressure chamber is divided into two partial chambers by the actuating means 4, which has a piston-like design, and these partial chambers can be exposed to pressure from a compressed air channel 11, 12 in each case. Exposure to pressure from the compressed air channel 11 means that the actuating means 4 can be displaced downwardly in the figure, and exposure to compressed air from the compressed air channel 12 means it can be displaced upwardly in the figure. Sealing means, which are not depicted for reasons of transparency, are typically arranged between the actuating means 4 and the side walls formed by the housing component 33. Further sealing means, which are typically arranged between different components, are also not depicted in FIG. 1 for reasons of transparency, since the design of the seals is not relevant to the essence of the invention.

The rotation of the actuating means 4 is likewise pneumatically actuated. The housing component 34 forms a further pressure chamber 16 for this purpose, in which a piston is mounted displaceably. Through exposure to pressure from the compressed air channels 13, 14, the piston 15 in the figure can be upwardly or downwardly displaced.

The piston 15 has a projection 17 which engages with a thread 18 of the actuating means 4, as a result of which a displacement of the piston 15 leads to a rotation of the actuating means 4. The piston 15 is secured to prevent rotation in this case by the guide means which is not shown.

The end of the actuating means 4 facing away from the gripping jaws 2, 3 is formed from a material 39 which has a low magnetic permeability, for example brass. In this way, it is possible to prevent the field lines of the magnet 19 from being conducted by the actuating means 4 to the housing component 33, which, in the case of the embodiment of the housing components 33, 35 made of ferromagnetic material, as explained later, would result in a large part of the field being guided past the magnetic field sensor 20. In order to be able to form the lower portion of the actuating means 4 in the figure from another material, the actuating means 4 is formed from two partial elements 36, 37 which are connected via a screw connection 38.

As has already been explained in the general section, it is advantageous, particularly with an embodiment of the receiving space 32 for the upper end of the actuating means 4 in the figure as a pressure chamber for pneumatic actuation, for the magnetic field sensor 20 to be arranged outside this receiving space 32. The magnetic field sensor in the example is therefore separated by the side wall 46 from the receiving space 32. Nevertheless, in order to enable there to be a substantially unimpeded detection of the magnetic field of the magnet 19 by the magnetic field sensor 20, the side wall 46 is formed from a material with a relative magnetic permeability close to one. The side wall 46 in the example is made of aluminum.

Through the housing component 35, a further receiving space 40 or sensor region 41 is jointly delimited with the side wall 46, which receives the magnetic field sensor 20. The housing component 35 is formed from a ferromagnetic material, for example from steel, and therefore acts as a shield 42 which, on the one hand, encloses the sensor region in the circumferential direction in relation to the rotational axis 7 and, on the other hand, ends at the side facing away from the magnet 19.

In order to avoid interference of the field lines in the region of the magnetic field sensor it is advantageous in this case for a certain minimum distance 44 to be observed between the portion of the housing 31, or the housing component 35, facing away from the magnet 19 and the magnetic field sensor 20. The minimum distance 44 should not be much smaller than the maximum possible distance between the magnetic field sensor 20 and the magnet 19 within the displacement path 6.

The housing component 33 is preferably also formed from a ferromagnetic material and therefore acts as a shield 42 in the region in which the magnet 19 is displaceable.

The housing 31, or the housing components 33, 35, therefore simultaneously act as a shield 42, 45, as a result of which the rotational information 25 and the gripping information 26 can be detected with a high degree of accuracy, even in the presence of interfering extraneous fields in the region of the rotary gripper 1.

While specific embodiments of the invention have been shown and described in detail to illustrate the inventive principles, it will be understood that the invention may be embodied otherwise without departing from such principles.

We claim:

1. A rotary gripper having two gripping jaws and an actuating means which is mounted by a bearing means, particularly formed by a housing, so as to be linearly displaceable along a displacement path and rotatable about a rotational axis running parallel to the displacement path, wherein the actuating means is movement-coupled with the gripping jaws in such a manner that the gripping jaws are displaced and/or swiveled during a displacement of the actuating means along the displacement path in opposite directions to one another, in order to adopt different gripping positions, and that a rotation of the actuating means about the rotational axis leads to a joint rotation of the gripping jaws about the rotational axis, wherein the rotary gripper has a magnet, a magnetic field sensor and a processing device, wherein the magnet is attached to the actuating means in such a manner that a magnetizing direction runs at an angle, in particular perpendicularly, to the rotational axis, wherein the magnetic field sensor is arranged in a stationary manner relative to the bearing means, such that the magnetic field of the magnet can be detected by the magnetic field sensor, wherein the magnetic field sensor is set up to detect components of the magnetic flux density of the magnetic field for at least two spatial directions, wherein the processing device is set up, depending on the components of the magnetic flux density detected, to detect rotational information relating to a rotational angle of the joint rotation of the gripping jaws and gripping information relating to the gripping position.

2. The rotary gripper according to claim 1, wherein the actuating means extends from an end coupled with the gripping jaws in the direction of the displacement path up to an end facing away from the gripping jaws, wherein the magnet is arranged on the end of the actuating means facing away from the gripping jaws, and is particularly arranged on an end face of the actuating means facing away from the gripping jaws.

3. The rotary gripper according to claim 2, wherein the actuating means is formed from a material which has a relative magnetic permeability at its end facing away from the gripping jaws of less than 4 or less than 2 or less than 1.5.

4. The rotary gripper according to claim 1, wherein the magnetic field sensor is arranged on a side of the actuating means facing away from the gripping jaws and spaced apart from the actuating means in the direction of the displacement path.

5. The rotary gripper according to claim 1, wherein at least one portion of the actuating means is received in a receiving space formed by the, or a, housing of the rotary gripper, wherein the magnetic field sensor is arranged on a side of a side wall of the receiving space facing away from the receiving space, wherein the side wall is formed at least sectionally from a material which has a relative magnetic permeability of less than 4 or less than 2 or less than 1.5.

6. The rotary gripper according to claim 5, wherein the, or a, housing of the rotary gripper exhibits a first housing component with which the actuating means engages, and which delimits the receiving space along with the side wall designed as a separate component, wherein on the side of the side wall facing away from the receiving space, a further receiving space which receives the magnetic field sensor is delimited by a second housing component along with the side wall.

7. The rotary gripper according to claim 1, wherein the displacement path runs at an angle of at least 30° or at least 60°, in particular perpendicular, to a plane which is formed by the spatial directions or two of the spatial directions, for which components of the magnetic field can be detected by the magnetic field sensor.

8. The rotary gripper according to claim 1, wherein it has a shield or that the housing forms a shield which encloses a sensor region, within which the magnetic field sensor is arranged, in the circumferential direction in relation to the rotational axis and/or which ends the sensor region on a side of the sensor region facing away from the magnet, wherein the shield is formed by a material with a relative magnetic permeability of at least 300.

9. The rotary gripper according to claim 1, wherein at least the, or a, portion of the actuating means is received in the, or a, receiving space formed by the, or a, housing of the rotary gripper, wherein the displacement of the actuating means along the displacement path is limited in such a manner that the magnet is arranged within the receiving space in all displacement positions of the actuating means, wherein the receiving space is limited in the circumferential direction in relation to the rotational axis by the, or a, material which has a relative magnetic permeability of at least 300.

10. The rotary gripper according to claim 1, wherein the processing device is set up, on the one hand, depending on the detected components of the magnetic flux density, to determine a measurement for an amount, either of the magnetic flux density or of the magnetic flux density projected into the plane formed by the spatial directions, and to determine the gripping information depending on this measurement, and/or on the other hand, to determine a ratio of the detected components of the magnetic flux density or two of these components, and to determine the rotational information depending on this ratio.
